(19) United States
(12) Patent Application Publication
(10) Pub. No.: US 2026/0153774 A1
(43) Pub. Date: Jun. 4, 2026

(54) ELECTROPHORETIC DISPLAY MODULE AND ELECTROPHORETIC DISPLAY APPARATUS

(71) Applicant: SAMSUNG ELECTRONICS CO., LTD., Suwon-si (KR)

(72) Inventor: Jinho KIM, Suwon-si (KR)

(73) Assignee: SAMSUNG ELECTRONICS CO., LTD., Suwon-si (KR)

(21) Appl. No.: 19/381,955

(22) Filed: Nov. 6, 2025

Related U.S. Application Data
(63) Continuation of application No. PCT/KR2025/015588, filed on Oct. 1, 2025.

(30) Foreign Application Priority Data
Nov. 29, 2024 (KR) 10-2024-0175930

(51) Int. Cl. G02F 1/1685; G02F 1/167; G02F 1/16766

(52) U.S. Cl. CPC G02F 1/1685; G02F 1/167; G02F 1/16766

(57) ABSTRACT

An electrophoretic display apparatus includes: a first substrate having a plurality of edges and including a plurality of pixel electrodes; a bezel coupled to a first edge of the plurality of edges of the first substrate; a second substrate arranged above the first substrate and configured to receive a reference voltage; a display medium layer arranged between the first substrate and the second substrate; and a driver configured to apply, to each pixel electrode of the plurality of pixel electrodes, a data voltage corrected based on a distance between the first edge of the first substrate and each pixel electrode of the plurality of pixel electrodes such that the reference voltage received by the second substrate and the corrected data voltage applied to each pixel electrode of the plurality of pixel electrodes drive the display medium layer.

### CROSS-REFERENCE TO RELATED APPLICATIONS

This application is a continuation application of international application No. PCT/KR2025/015588, filed on October 1, 2025, which claims priority under 35 U. S. C. §119 to Korean Patent Application No. 10-2024-0175930, filed on November 29, 2024, the disclosures of which are incorporated herein by reference in their entireties.

### TECHNICAL FIELD

The disclosure relates to an electrophoretic display module and an electrophoretic display apparatus including a plurality of electrophoretic display modules.

### BACKGROUND ART

An electrophoretic display (EPD) apparatus is a flat panel display apparatus that displays an image using an electrophoretic phenomenon. The electrophoretic phenomenon refers to the movement of charged particles toward an electrode within an electric field, and the electrophoretic display apparatus is an apparatus that applies this phenomenon to a display.

An existing electrophoretic display apparatus has a structure in which microcapsules are disposed between a lower substrate and an upper substrate with transparent electrodes, and the microcapsules contain positively and negatively charged particles of different colors dispersed along with transparent fluid. In such a structure, when a voltage is applied between the upper and lower electrodes, the charged particles move to the upper or lower electrodes due to the electric field, thereby displaying an image.

Electrophoretic display apparatuses are distinguished from light-emitting display apparatuses in that the electrophoretic display apparatus is based on a reflective display method that causes less eye fatigue and provides wide viewing angles and high visibility even in environments with strong external light.

Meanwhile, in order to manufacture a large-sized electrophoretic display apparatus, manufacturing a plurality of electrophoretic display modules and then combining the plurality of electrophoretic display modules are required.

A bezel is formed on all edges of the electrophoretic display module. Accordingly, when a plurality of electrophoretic display modules are combined, the seams between the plurality of electrophoretic display modules are noticeable, which causes inconvenience to a user.

### Disclosure

### Technical Problem

The disclosure provides an electrophoretic display module in which a bezel is formed on only one edge of a substrate, and an electrophoretic display apparatus including a plurality of electrophoretic display modules.

The disclosure provides an electrophoretic display module that may prevent a disadvantage that may be caused by forming a bezel only on one edge of a substrate, and an electrophoretic display apparatus including a plurality of electrophoretic display modules.

Technical aspects that can be achieved by the disclosure are not limited to the above-mentioned aspects, and other technical aspects not mentioned will be clearly understood by one of ordinary skill in the technical art to which the disclosure belongs from the following description.

### Technical Solution

According to an embodiment of the disclosure, an electrophoretic display module may include: a first substrate including a plurality of pixel electrodes; a bezel coupled to a first edge of the first substrate; a second substrate arranged above the first substrate and configured to receive a reference voltage; a display medium layer arranged between the first substrate and the second substrate; and a driver configured to apply, to each of the plurality of pixel electrodes, a data voltage corrected based on a distance between the first edge of the first substrate and each of the plurality of pixel electrodes.

According to an embodiment of the disclosure, an electrophoretic display apparatus may include the plurality of electrophoretic display modules, and at least one of remaining edges of the first substrate of each of the plurality of electrophoretic display modules, other than the first edge of the first substrate, may be in contact with at least one of remaining edges of the first substrate of another electrophoretic display module among the plurality of electrophoretic display modules, other than the first edge of the first substrate.

According to an embodiment of the disclosure, an electrophoretic display module may include: a first substrate including a display area on which a plurality of pixel electrodes are provided; a first bezel coupled to a first edge of the first substrate; a second bezel coupled to a second edge opposite to the first edge of the first substrate; a second substrate arranged above the first substrate and configured to receive a reference voltage; a display medium layer arranged between the first substrate and the second substrate; and a driver configured to apply, to each of the plurality of pixel electrodes, a data voltage corrected based on a distance between a virtual reference line between the first edge and the second edge of the first substrate and each of the plurality of pixel electrodes.

### DESCRIPTION OF DRAWINGS

FIG. 1 illustrates an example of an electrophoretic display module viewed from above according to an embodiment.

FIG. 2 illustrates an example of an electrophoretic display module viewed from a side according to an embodiment.

FIG. 3 schematically illustrates a plurality of pixel electrodes on a driving substrate of an electrophoretic display module according to an embodiment.

FIG. 4 is a control block diagram of an example of an electrophoretic display module according to an embodiment.

FIG. 5 is a flowchart illustrating an example method for driving an electrophoretic display module according to an embodiment.

FIG. 6 illustrates that a reference voltage applied to a common electrode layer decreases due to a voltage drop as a distance from a first edge of a first substrate increases.

FIG. 7 is a graph illustrating a data voltage correction amount of a driver according to an embodiment.

FIG. 8 is a diagram illustrating an example in which a target data voltage according to image data is corrected.

FIG. 9 illustrates an example of an electrophoretic display apparatus according to an embodiment.

FIG. 10 illustrates another example of an electrophoretic display apparatus according to an embodiment.

FIG. 11 illustrates another example of an electrophoretic display module according to an embodiment.

FIG. 12 illustrates that a reference voltage applied to a common electrode layer decreases due to a voltage drop as a distance to a virtual reference line of a substrate decreases.

FIG. 13 is a diagram illustrating a data voltage correction amount of a driver according to an embodiment.

FIG. 14 is a diagram illustrating an example in which a target data voltage according to image data is corrected.

### MODES OF THE DISCLOSURE

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

The term of "and/or" includes a plurality of combinations of relevant items or any one item among a plurality of relevant items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” or “above” another element, it may be directly on the other element or intervening elements may also be present.

Hereinafter, embodiments of the disclosure will be described in detail with reference to the accompanying drawings.

In the disclosure, an electrophoretic display module and an electrophoretic display apparatus are devices capable of processing an image signal received from an external source and visually displaying a processed image.

The electrophoretic display module and the electrophoretic display apparatus may be implemented in various forms, such as a television, a monitor, a portable multimedia device, an e-book, a portable communication device, and the like, and the form of the electrophoretic display module and the electrophoretic display apparatus is not limited as long as it is a device that visually displays an image.

In addition, the electrophoretic display module and the electrophoretic display apparatus may be a large format display (LFD) installed outdoors, such as on a building rooftop or at a bus stop. Here, the outdoors is not limited to the open air, and the electrophoretic display module and the electrophoretic display apparatus according to an embodiment may be installed in places where a large number of people come and go, such as subway stations, shopping malls, movie theaters, offices, or stores.

The electrophoretic display module and the electrophoretic display apparatus may receive content including a video signal and an audio signal from various content sources, and may output video and audio corresponding to the video signal and the audio signal, respectively. For example, the electrophoretic display module and the electrophoretic display apparatus may receive content data through a broadcast reception antenna or a wired cable, receive content data from a content playback apparatus, receive content data from a content-providing server of a content provider, or receive content data from a storage medium in which content data is stored.

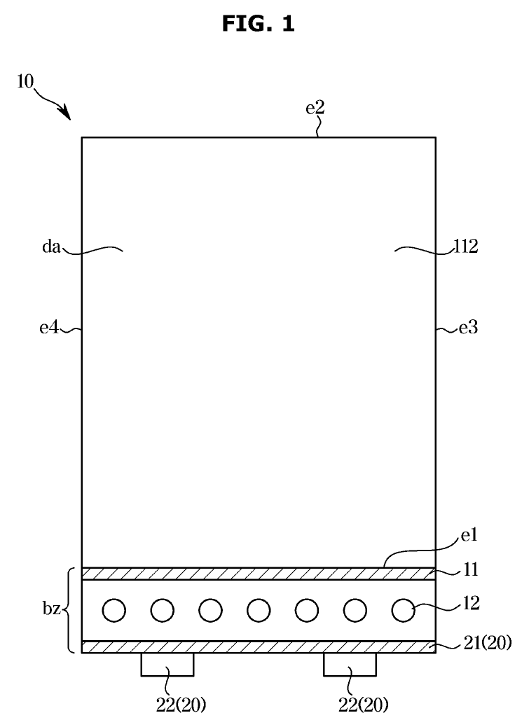

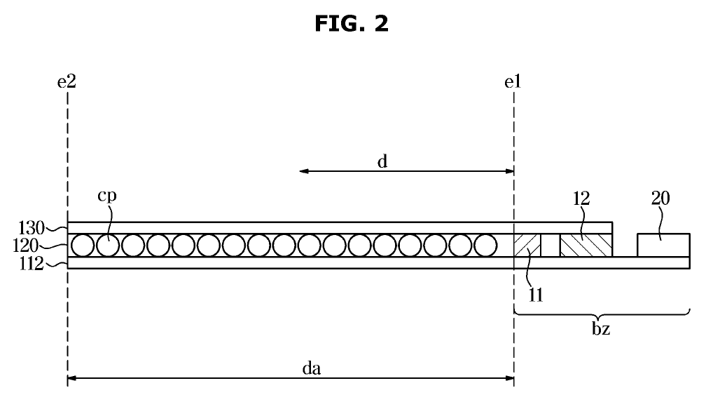

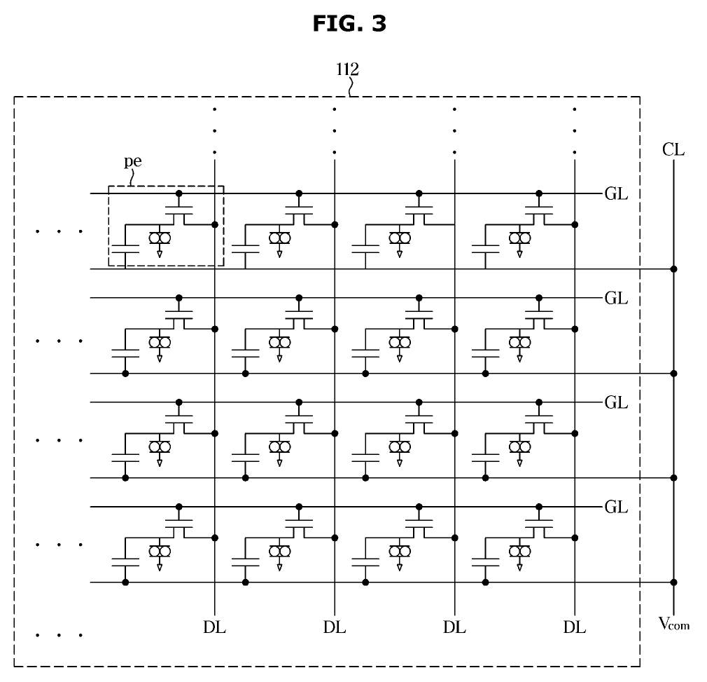

FIG. 1 illustrates an example of an electrophoretic display module viewed from above according to an embodiment. FIG. 2 illustrates an example of an electrophoretic display module viewed from a side according to an embodiment. FIG. 3 schematically illustrates a plurality of pixel electrodes provided on a driving substrate of an electrophoretic display module according to an embodiment.

Referring to FIG. 1, FIG. 2, and FIG. 3, an electrophoretic display module 10 may include a first substrate 112 on which a plurality of pixel electrodes pe are provided.

The first substrate 112 may include at least one edge (e.g., a first edge e1, a second edge e2, a third edge e3, and a fourth edge e4).

In the disclosure, the first substrate 112 may be defined as a driving substrate in that the first substrate 112 includes the plurality of pixel electrodes pe.

In the disclosure, the first substrate 112 may be defined as a lower substrate in that the first substrate 112 is arranged below a second substrate 130.

Driving a display medium layer 120 may include moving ink inside a capsule included in the display medium layer 120.

The plurality of pixel electrodes pe may include at least one capacitor and/or at least one transistor.

In the disclosure, the pixel electrode pe may also be referred to as a pixel circuit.

The second substrate 130 may be arranged above the first substrate 112.

A reference voltage V_{com} (or referred to as a common voltage) for driving the display medium layer 120 may be applied to the second substrate 130.

The second substrate 130 may be made of a transparent material so that an image represented by ink in a capsule included in the display medium layer 120 may be transmitted through the second substrate 130.

The second substrate 130 may be defined as an upper substrate in that the second substrate 130 is disposed on the upper side of the first substrate 112.

The second substrate 130 may be referred to as a common electrode substrate in that the reference voltage V_{com} is applied thereto.

The second substrate 130 may be referred to as a transparent substrate in that the second substrate 130 is transparent.

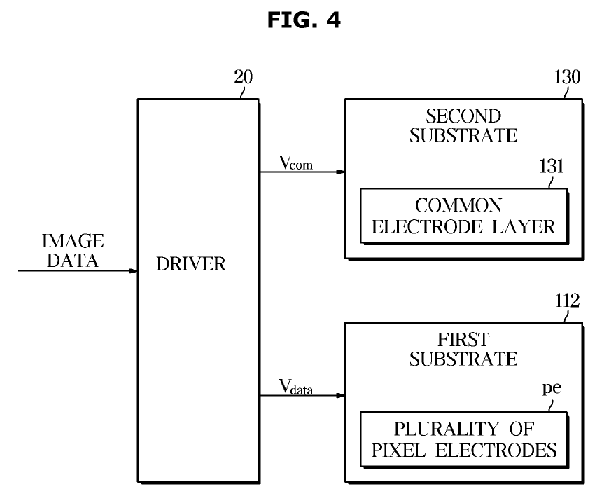

The second substrate 130 may include a common electrode layer 131 (see FIG. 4) to which the reference voltage V_{com} is applied, a water vapor inflow prevention layer that prevents inflow of water vapor, and a cover layer that covers the common electrode layer and/or the water vapor inflow prevention layer.

A common electrode line CL to which the reference voltage V_{com} is applied may be formed on the common electrode layer 131.

The display medium layer 120 may be arranged between the first substrate 112 and the second substrate 130.

The display medium layer 120 may include a plurality of electrophoretic charged particles. The plurality of charged particles may be provided in an insulating dispersion medium cp. The insulating dispersion medium may be referred to as a capsule.

The capsule cp may include at least one of a hydrocarbon-based solvent, a silicon-based solvent, or a halogenated solvent. For example, the capsule cp may be formed by a polymer shell such as melamine resin, urea resin, acrylic resin, and polyurethane.

The plurality of charged particles may include a first particle group that includes a white pigment and is positively charged, and a second particle group that includes a black pigment and is negatively charged.

According to various embodiments, to implement a color image, the plurality of charged particles may include particle groups that include red, green, and/or blue pigments and are positively and/or negatively charged.

At least one capsule cp included in the display medium layer 120 may correspond to at least one pixel electrode pe on the first substrate 112.

A charged pigment inside the at least one capsule cp may move within the capsule according to a potential difference between a data voltage applied to the corresponding pixel electrode pe and the reference voltage V_{com}. Accordingly, a pigment of a first color charged positively or negatively inside the capsule may move toward the second substrate 130, and a pigment of a second color charged negatively or positively may move toward the first substrate 112.

For example, in a case where a voltage lower than the reference voltage V_{com} (a negative voltage) is applied to the pixel electrode pe, the first-colored pigment that is negatively charged may move toward the second substrate 130, and the second-colored pigment that is positively charged may move toward the first substrate 112.

As another example, in a case where a voltage higher than the reference voltage V_{com} (a positive voltage) is applied to the pixel electrode pe, the first-colored pigment that is positively charged may move toward the second substrate 130, and the second-colored pigment that is negatively charged may move toward the first substrate 112.

A user may observe the pigment that has moved toward the second substrate 130. As such, the electrophoretic display module 10 may display an image by adjusting the data voltage applied to each of the plurality of pixel electrodes pe.

An area where an image is displayed may be defined as a display area da. A plurality of capsules and/or a plurality of pixel electrodes pe may be formed below the display area da.

That is, the display area da may refer to an area where capsules and/or pixel electrodes pe are provided thereunder, and a peripheral area, or the like may be referred to an area where no capsule and/or no pixel electrode pe is provided thereunder.

The display area da may also be referred to as an active area.

The pigment moved by applying the data voltage and the reference voltage V_{com} may maintain its position even when the potential difference between the first substrate 112 and the second substrate 130 disappears.

A data line DL for applying a data voltage to each of the plurality of pixel electrodes pe may be formed on the first substrate 112.

A scan line (or gate line) GL for applying a scan signal to each of the plurality of pixel electrodes pe may be formed on the first substrate 112.

A bezel bz may be coupled to the first edge e1 of the first substrate 112.

A bezel may not be formed on the remaining edges (e.g., the second edge e2, the third edge e3, and/or the third edge e3) other than the first edge e1 of the first substrate 112.

For example, no bezel may be formed on the second edge e2, the third edge e3, and the fourth edge e4 of the first substrate 112.

In an embodiment, the electrophoretic display module 10 may be referred to as a 3-side bezel-less display module.

An electrostatic discharge prevention circuit 11 may be formed on the bezel bz. The electrostatic discharge prevention circuit 11 may be disposed near the first edge e1 of the first substrate 112 to prevent static electricity, introduced through various paths, from being transmitted to the plurality of pixel electrodes pe formed on the first substrate 112.

A conductive member(or conductive material) 12 may be formed in the bezel bz.

The conductive member 12 may be formed by applying a silver (Ag) paste to the bezel bz in a dot form.

The conductive member 12 may apply the reference voltage V_{com} to the second substrate 130. Here, applying the reference voltage V_{com} to the second substrate 130 may include transmitting the reference voltage V_{com} received from a driver 20 to the second substrate 130.

Applying the reference voltage V_{com} to the second substrate 130 may include applying the reference voltage V_{com} to the common electrode layer 131 (see FIG. 4) formed on the second substrate 130.

That is, the conductive member 12 may electrically connect the driver 20 and the second substrate 130.

A plurality of the conductive members 12 may be formed to be spaced apart from each other by a predetermined interval in a width direction of the bezel bz.

Meanwhile, unlike existing technologies in which the bezel bz is formed on all edges of the first substrate 112, the bezel bz is formed only on the first edge e1 of the first substrate 112, and thus a magnitude of the reference voltage V_{com} applied to the second substrate 130 through the conductive member 12 decreases due to a voltage drop as a distance d from the first edge e1 increases.

The driver 20 may be formed on the bezel bz. The driver 20 may receive an image data signal from a content source portion and may control the plurality of pixel electrodes pe based on the received image data signal.

The driver 20 may include a driving integrated chip (IC, 22). The driving IC 22 may include a data driver IC (or source driver IC) that transmits a data signal (or data voltage) to each of the plurality of pixels and/or a gate driver IC (or scan driver IC) that transmits a gate signal to each of the plurality of pixels.

For example, the driver 20 may include a chip on film (COF) and a Stiffener printed circuit board (SPCB).

The driver 20 may include fan-out wiring 21 that electrically connects the wiring (DL, GL) formed on the first substrate 112 and the driving IC 22.

For example, the driver 20 may be electrically connected to the data line DL formed on the first substrate 112. For example, the driver 20 may include data fan-out wiring 21 that electrically connects the driving IC 22 and the data line DL.

For example, the driver 20 may be electrically connected to the scan line GL formed on the first substrate 112. For example, the driver 20 may include gate fan-out wiring 21 that electrically connects the driving IC 22 and the scan line GL.

According to the disclosure, design freedom may be improved because the bezel bz is provided only on the first edge e1 of the first substrate 112, and not on the remaining edges.

For example, according to the disclosure, a seamless electrophoretic display apparatus may be manufactured by using a plurality of electrophoretic display modules 10.

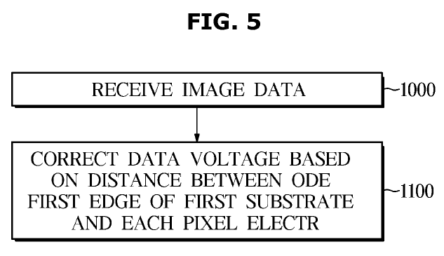

FIG. 4 is a control block diagram of an example of the electrophoretic display module 10 according to an embodiment. FIG. 5 is a flowchart illustrating an example method for driving the electrophoretic display module 10 according to an embodiment.

Referring to FIG. 4 and FIG. 5, the driver 20 according to an embodiment may receive image data (1000).

In the disclosure, the image data may be data corresponding to an image signal received from an external source, or data obtained by preprocessing the data corresponding to the image signal received from the external source.

For example, the image data may include information about a target data voltage applied to each of the plurality of pixel electrodes pe and/or timing information at which the target data voltage is applied to each of the plurality of pixel electrodes pe.

The information about the target data voltage applied to each of the plurality of pixel electrodes pe may be referred to as a data value, a pixel value, or the like.

In the disclosure, the image data may also be referred to as input data.

The driver 20 may apply the reference voltage V_{com} to the common electrode layer 131 formed on the second substrate 130 based on receiving the image data.

To this end, the driver 20 may be electrically connected to the conductive member 12.

The reference voltage V_{com} may also be referred to as a common voltage in that the reference voltage V_{com} is applied to correspond to all of the plurality of pixel electrodes pe.

The driver 20 may correct a target data voltage corresponding to the image data based on a distance between the first edge e1 of the first substrate 112 and each of the plurality of pixel electrodes pe (1100).

Based on receiving the image data, the driver 20 may apply, to each of the plurality of pixel electrodes pe formed on the first substrate 112, a data voltage V_{data} corrected based on the distance between the first edge e1 of the first substrate 112 and each of the plurality of pixel electrodes pe.

In the disclosure, the corrected data voltage V_{data} may refer to the target data voltage, corresponding to the data value, that has been corrected.

Depending on the distance d between the first edge e1 of the first substrate 112 and each of the plurality of pixel electrodes pe, the corrected data voltage V_{data} may be the same as the target data voltage corresponding to the image data or may be the adjusted target data voltage.

The distance d between the first edge e1 of the first substrate 112 and each of the plurality of pixel electrodes pe may correspond to a distance from a distal end of the bezel bz to each of the plurality of pixel electrodes pe, a distance from an edge of the second substrate 130 to each of the plurality of pixel electrodes pe, and/or a distance from an edge of the display area da to each of the plurality of pixel electrodes pe, and the like.

Hereinafter, for convenience of description, the distance d between the first edge e1 of the first substrate 112 and each of the plurality of pixel electrodes pe will be referred to as a reference distance d.

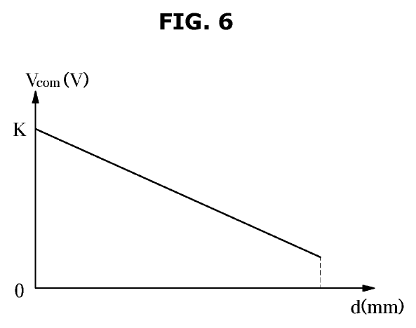

FIG. 6 illustrates that the reference voltage V_{com} applied to the common electrode layer decreases due to a voltage drop as a distance from the first edge e1 of the first substrate 112 increases.

Referring to FIG. 6, as the reference distance d increases, the magnitude of the reference voltage V_{com} applied to the common electrode layer 131 decreases due to a voltage drop.

The decrease is due to the conductive member 12 which is not provided on all edges of the first substrate 112. That is, according to the disclosure, because the bezel bz is formed only on the first edge e1 of the first substrate 112 and the conductive member 12 is provided in the bezel bz, the magnitude of the voltage of the common electrode layer decreases as the distance from the first edge e1 of the first substrate 112 increases.

For example, a voltage magnitude of the common electrode layer 131 may be greater in a portion relatively close to the first edge e1 of the first substrate 112 than in a portion relatively far from the first edge e1 of the first substrate 112.

That is, a magnitude K of the reference voltage V_{com} transmitted by the conductive member 12 gradually decreases as the reference distance d increases.

Due to such a voltage drop, in a case where a target data voltage is applied to the pixel electrode pe that is far from the first edge e1 of the first substrate 112, a potential difference between the target data voltage and the common voltage may differ from an intended potential difference.

In a case where the potential difference between the target data voltage and the common voltage differs from the intended potential difference, uniformity of the image displayed on the electrophoretic display module 10 is reduced, and a reflectance and color coordinates of a portion represented by a pixel that is far from the first edge e1 of the first substrate 112 change.

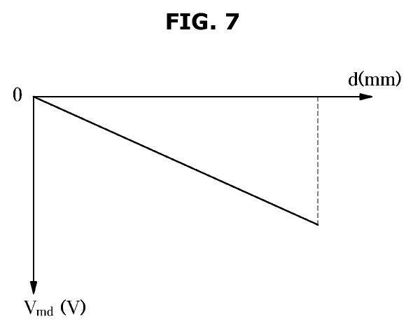

FIG. 7 is a graph illustrating a data voltage correction amount of the driver 20 according to an embodiment.

Referring to FIG. 7, the driver 20 according to an embodiment may correct a target data voltage based on a correction amount V_{md} of a data voltage determined according to a reference distance d.

The correction amount V_{md} of the data voltage may increase as the reference distance d increases. The correction amount V_{md} of the data voltage may be proportional to the reference distance d.

An increase rate of the correction amount V_{md} of the data voltage according to the reference distance d may correspond to a decrease rate of the common voltage V_{com} according to the reference distance d.

For example, assuming that the common voltage V_{com} decreases by 0.2V when the reference distance d is 2mm, the correction amount V_{md} of the data voltage may also be 0.2V when the reference distance d is 2mm.

In the disclosure, the correction amount V_{md} of the data voltage refers to the magnitude of the correction voltage, and the correction voltage may have a negative sign. That is, assuming that the common voltage V_{com} decreases by 0.2V when the reference distance d is 2mm, the data voltage may decrease by 0.2V when the reference distance d is 2mm.

For example, the common voltage V_{com} according to the reference distance d may be measured through experiments, and the correction amount V_{md} of the data voltage may be defined by the measured common voltage V_{com} according to the reference distance d.

That is, the correction amount V_{md} of the data voltage according to the reference distance d shown in FIG. 7 may be obtained in advance through experiments.

The driver 20 may determine a target data voltage applied to each of the plurality of pixel electrodes pe based on the image data, and determine the corrected data voltage V_{data} by correcting the target data voltage based on the distance between the first edge e1 of the first substrate 112 and each of the plurality of pixel electrodes pe.

For example, the driver 20 may determine the corrected data voltage V_{data} by subtracting or adding the correction amount V_{md} of the data voltage from or to the target data voltage.

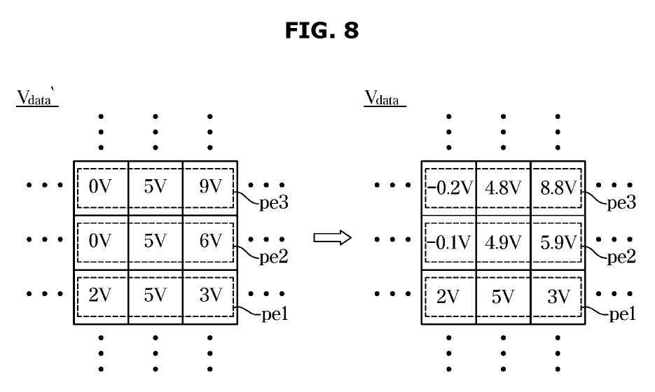

FIG. 8 is a diagram illustrating an example in which a target data voltage according to image data is corrected.

The table shown on the left side of FIG. 8 represents a target data voltage V_{data} corresponding to each of the plurality of pixel electrodes pe included in image data, and the table shown on the right side of FIG. 8 represents a corrected data voltage V_{data} corresponding to each of the plurality of pixel electrodes pe.

Referring to FIG. 8, the plurality of pixel electrodes pe may include first pixel electrodes pe1 of a first group which are a first distance away from the first edge e1, second pixel electrodes pe2 of a second group which are a second distance away from the first edge e1, and third pixel electrodes pe3 of a third group which are a third distance away from the first edge e1.

The distances may increase in the order of the first distance, the second distance, and the third distance, and for convenience of description, the first distance is assumed to be 0mm.

In a case where the target data voltages corresponding to the first pixel electrode pe1 and the second pixel electrode pe2 are a first data voltage and a second data voltage, respectively, the driver 20 may adjust the first data voltage by a first voltage and apply the adjusted data voltage to the first pixel electrode pe1, and adjust the second data voltage by a second voltage and apply the adjusted data voltage to the second pixel electrode pe2, wherein a magnitude of the second voltage (e.g., 0.1V) may be greater than that of the first voltage (e.g., 0V).

In a case where the target data voltages corresponding to the second pixel electrode pe2 and the third pixel electrode pe3 are a second data voltage and a third data voltage, respectively, the driver 20 may adjust the second data voltage by a second voltage and apply the adjusted data voltage to the second pixel electrode pe2, and adjust the third data voltage by a third voltage and apply the adjusted data voltage to the third pixel electrode pe3, wherein a magnitude of the third voltage (e.g., 0.3V) may be greater than that of the second voltage (e.g., 0.2V).

As such, according to the disclosure, a change in potential difference between the reference voltage V_{com} and the target data voltage V_{data}_{’} due to a change in the magnitude of the reference voltage V_{com} according to the reference distance d may be prevented by correcting the data voltage V_{data}_{’}.

According to the disclosure, even though the bezel bz including the conductive member 12 is formed only on the first edge e1 of the first substrate 112, the magnitude of the reference voltage V_{com} may change according to the reference distance d, thereby preventing the potential difference between the reference voltage V_{com} and the target data voltage V_{data}_{’} from changing.

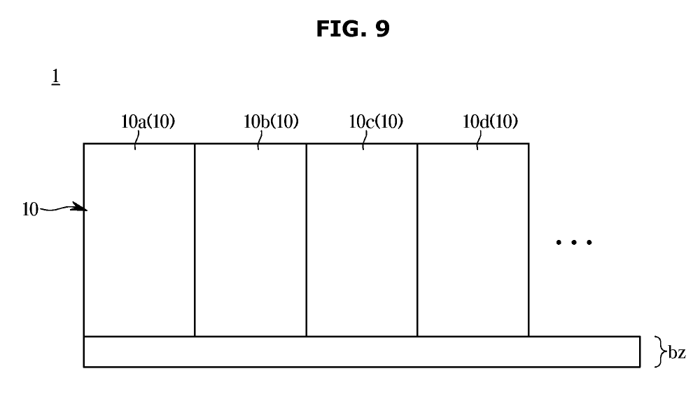

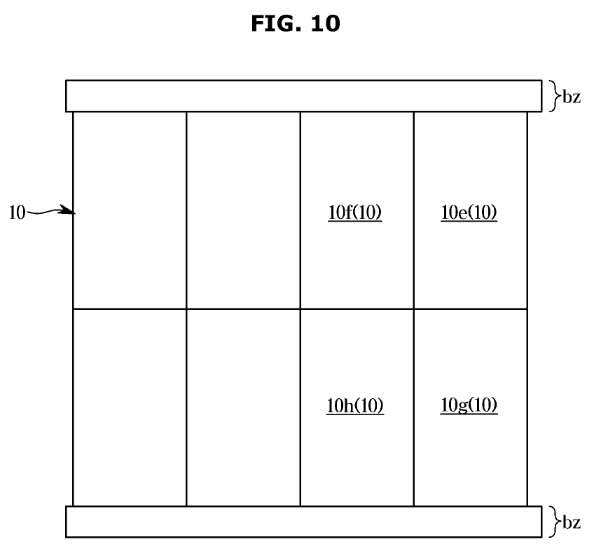

FIG. 9 illustrates an example of an electrophoretic display apparatus according to an embodiment. FIG. 10 illustrates another example of an electrophoretic display apparatus according to an embodiment.

Referring to FIG. 9 and FIG. 10, the electrophoretic display apparatus 1 according to an embodiment may include a plurality of electrophoretic display modules 10.

In the case of the electrophoretic display module 10 according to an embodiment, because the bezel bz is formed only on the first edge e1, when the portions where the bezel bz is formed are aligned, the first substrates 112 may come into contact without a seam.

At least one of the remaining edges of the first substrate 112 of each of the plurality of electrophoretic display modules 10, other than the first edge e1 of the first substrate 112, may be in contact with at least one of the remaining edges of the first substrate 112 of another electrophoretic display module 10 among the plurality of electrophoretic display modules 10, other than the first edge e1 of the first substrate 112.

Referring to FIG. 9, the plurality of electrophoretic display modules 10 may include a first electrophoretic display module 10a, a second electrophoretic display module 10b, a third electrophoretic display module 10c, and a fourth electrophoretic display module 10d arranged in the same row.

A third edge e3 of the first electrophoretic display module 10a may be in contact with a fourth edge e4 of the second electrophoretic display module 10b. A third edge e3 of the second electrophoretic display module 10b may be in contact with a fourth edge e4 of the third electrophoretic display module 10c. A third edge e3 of the third electrophoretic display module 10c may be in contact with a fourth edge e4 of the fourth electrophoretic display module 10d.

Referring to FIG. 10, the plurality of electrophoretic display modules 10 may include a fifth electrophoretic display module 10e, a sixth electrophoretic display module 10f, a seventh electrophoretic display module 10g, and an eighth electrophoretic display module 10h arranged in a matrix form.

A third edge e3 of the fifth electrophoretic display module 10e may be in contact with a fourth edge e4 of the sixth electrophoretic display module 10f. A second edge e2 of the fifth electrophoretic display module 10e may be in contact with a second edge e2 of the seventh electrophoretic display module 10g.

A second edge e2 of the sixth electrophoretic display module 10f may be in contact with a second edge e2 of the eighth electrophoretic display module 10h.

A third edge e3 of the eighth electrophoretic display module 10h may be in contact with a fourth edge e4 of the seventh electrophoretic display module 10g.

According to the disclosure, a single seamless electrophoretic display apparatus may be implemented by using a plurality of electrophoretic display modules 10.

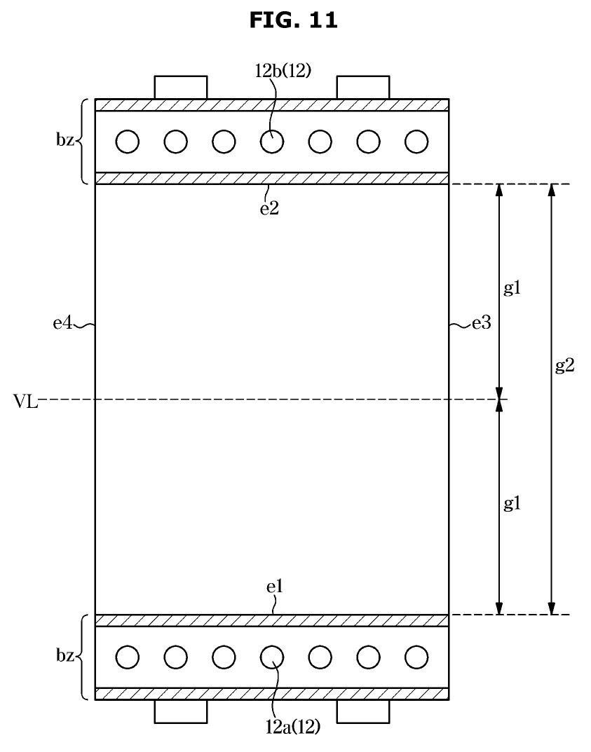

FIG. 11 illustrates another example of the electrophoretic display module 10 according to an embodiment.

In an embodiment, the electrophoretic display module 10 may include a first bezel bz1 coupled to the first edge e1 of the first substrate 112, and a second bezel bz2 coupled to a second edge e2 opposite the first edge e1 of the first substrate 112.

No bezel may be formed on a third edge e3 and a fourth edge e4 of the first substrate 112.

That is, in an embodiment, the electrophoretic display module 10 may be referred to as a 2-side bezel-less display module.

An electrostatic discharge prevention circuit 11 may be formed on each of the bezels bz1 and bz2. The electrostatic discharge prevention circuit 11 may be disposed near the first edge e1 and near the second edge e2 of the first substrate 112 to prevent static electricity, introduced through various paths, from being transmitted to the plurality of pixel electrodes pe formed on the first substrate 112.

The conductive member 12 may be formed in each of the bezels bz1 and bz2.

For example, a first conductive member 12a may be formed in the first bezel bz1, and a second conductive member 12b may be formed in the second bezel bz2.

The first conductive member 12a and the second conductive member 12b may receive the reference voltage V_{com} from the driver 20 provided on each of the bezels bz1 and bz2.

When the conductive members 12a and 12b formed in each of the bezels bz provided at both ends of the first substrate 112 receive the reference voltage V_{com}, the reference voltage V_{com} applied to the common electrode layer 131 decreases due to a voltage drop as a distance from the first edge e1 or the second edge e2 of the first substrate 112 increases up to a midpoint between the first edge e1 and the second edge e2 of the first substrate 112.

That is, assuming that there is a virtual reference line VL that passes through the midpoint between the first edge e1 and the second edge e2 of the first substrate 112 and is parallel to the first edge e1 and the second edge e2 of the first substrate 112, the reference voltage V_{com} applied to the common electrode layer 131 may decrease as a distance to the virtual reference line VL decreases.

A distance (g2-g1) from the first edge e1 to the virtual reference line VL may be the same as a distance g1 from the second edge e2 to the virtual reference line VL.

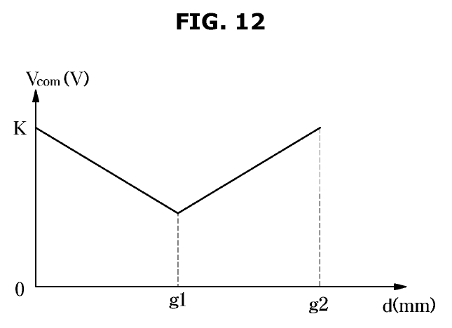

FIG. 12 illustrates that the reference voltage V_{com} applied to the common electrode layer decreases due to a voltage drop as a distance to a virtual reference line of the substrate decreases.

Alternatively, a distance d between the second edge e2 of the first substrate 112 and each of the plurality of pixel electrodes pe is referred to as a reference distance d.

Assuming that a distance d between the first edge e1 of the first substrate 112 and each of the plurality of pixel electrodes pe is the reference distance d, referring to FIG. 12, as the reference distance d increases, the magnitude of the reference voltage V_{com} applied to the common electrode layer 131 decreases due to a voltage drop, and then when a reference distance d reaches the distance g1 from the first edge e1 to the virtual reference line VL, the magnitude of the reference voltage V_{com} increases as the reference distance d increases.

Assuming that the distance d between the second edge e2 of the first substrate 112 and each of the plurality of pixel electrodes pe is the reference distance d, referring to FIG. 12, as the reference distance d increases, the magnitude of the reference voltage V_{com} applied to the common electrode layer 131 decreases due to a voltage drop, and then when a reference distance d reaches the distance g1 from the second edge e2 to the virtual reference line VL, the magnitude of the reference voltage V_{com} increases as the reference distance d increases.

That is, the reference voltage V_{com} may decrease due to voltage drop as a distance to the virtual reference line VL decreases, and may increase as the distance from the virtual reference line VL increases.

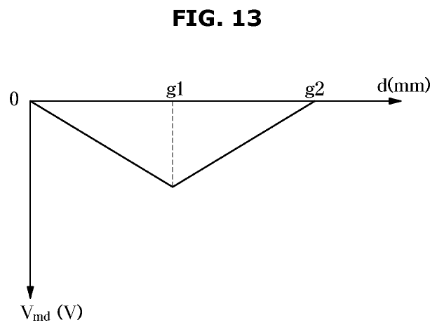

FIG. 13 is a diagram illustrating a data voltage correction amount of the driver 20 according to an embodiment.

Referring to FIG. 13, the driver 20 according to an embodiment may correct a target data voltage based on the correction amount V_{md} of data voltage determined according to the reference distance d.

The correction amount V_{md} of the data voltage may increase as the reference distance d is similar to the distance g1 from the first edge e1 or the second edge e2 to the virtual reference line.

An increase rate of the correction amount V_{md} of the data voltage according to the reference distance d may correspond to a decrease rate of the common voltage V_{com} according to the reference distance d.

For example, assuming that the common voltage V_{com} decreases by 0.2V when the reference distance d is 2mm, the correction amount V_{md} of the data voltage may also be 0.2V when the reference distance d is 2mm.

The correction amount V_{md} of the data voltage may be inversely proportional to a distance between the virtual reference line VL and each of the plurality of pixel electrodes pe.

In the disclosure, the correction amount V_{md} of the data voltage refers to the magnitude of the correction voltage, and the correction voltage may have a negative sign. That is, assuming that the common voltage V_{com} decreases by 0.2V when the reference distance d is 2mm, the data voltage may decrease by 0.2V when the reference distance d is 2mm.

For example, the common voltage V_{com} according to the reference distance d may be measured through experiments, and the correction amount V_{md} of the data voltage may be defined by the measured common voltage V_{com} according to the reference distance d.

That is, the correction amount V_{md} of the data voltage according to the reference distance d shown in FIG. 13 may be obtained in advance through experiments.

The driver 20 may determine a target data voltage applied to each of the plurality of pixel electrodes pe based on image data, and determine the corrected data voltage V_{data} by correcting the target data voltage based on the distance d between the first edge e1 of the first substrate 112 and each of the plurality of pixel electrodes pe.

For example, the driver 20 may determine the corrected data voltage V_{data} by subtracting or adding the correction amount V_{md} of the data voltage from or to the target data voltage.

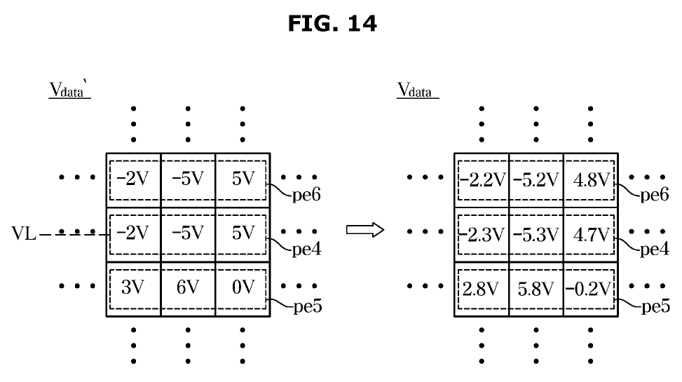

FIG. 14 is a diagram illustrating an example in which a target data voltage according to image data is corrected.

The table shown on the left side of FIG. 14 represents a target data voltage V_{data}` corresponding to each of the plurality of pixel electrodes pe included in image data, and the table shown on the right side of FIG. 14 represents a corrected data voltage V_{data} corresponding to each of the plurality of pixel electrodes pe.

Referring to FIG. 14, the plurality of pixel electrodes pe may include fourth pixel electrodes pe4 of a fourth group which are a first distance away from a virtual reference line, fifth pixel electrodes pe5 of a fifth group which are a second distance away from the virtual reference line, and sixth pixel electrodes pe6 of a sixth group which are the second distance away from the virtual reference line.

The fifth pixel electrodes pe5 and the sixth pixel electrodes pe6 may be disposed at positions symmetrical to each other with respect to the virtual reference line VL.

The distances may increase in the order of the first distance and the second distance, and for convenience of description, the first distance is assumed to be0mm.

In a case where the target data voltages corresponding to the fourth pixel electrode pe4 and the fifth pixel electrode pe5 are a fourth data voltage and a fifth data voltage, respectively, the driver 20 may adjust the fourth data voltage by a fourth voltage and apply the adjusted data voltage to the fourth pixel electrode pe4, and adjust the fifth data voltage by a fifth voltage and apply the adjusted data voltage to the fifth pixel electrode pe5, wherein a magnitude of the fourth voltage (e.g., 0.3V) may be greater than that of the fifth voltage (e.g., 0.2V).

In a case where the target data voltages corresponding to the fourth pixel electrode pe4 and the sixth pixel electrode pe6 are a fourth data voltage and a sixth data voltage, respectively, the driver 20 may adjust the fourth data voltage by a fourth voltage and apply the adjusted data voltage to the fourth pixel electrode pe4, and adjust the sixth data voltage by a sixth voltage and apply the adjusted data voltage to the sixth pixel electrode pe6, wherein a magnitude of the fourth voltage (e.g., 0.3V) may be greater than that of the sixth voltage (e.g., 0.2V).

In a case where the target data voltages corresponding to the fifth pixel electrode pe5 and the sixth pixel electrode pe6 are a fifth data voltage and a sixth data voltage, respectively, the driver 20 may adjust the fifth data voltage by a fifth voltage and apply the adjusted data voltage to the fifth pixel electrode pe5, and adjust the sixth data voltage by a sixth voltage and apply the adjusted data voltage to the sixth pixel electrode pe6, wherein a magnitude of the fifth voltage (e.g., 0.2V) may be the same as that of the sixth voltage (e.g., 0.2V).

The embodiments described in FIG. 12, FIG. 13, and FIG. 14 may be equally applied to the electrophoretic display apparatus shown in FIG. 10.

According to the disclosure, even without forming the bezel bz on all edges of the display area, the decrease in the reflectance/color coordinates of a pixel due to a voltage drop of common voltage may be prevented.

According to the disclosure, a seamless electrophoretic display apparatus may be manufactured by coupling together the portions of each electrophoretic display module 10 where the bezel bz is not present.

According to an embodiment of the disclosure, an electrophoretic display module 10 may include: a first substrate 112 including a plurality of pixel electrodes pe; a bezel bz coupled to a first edge e1 of the first substrate 112; a second substrate 130 arranged above the first substrate 112 and configured to receive a reference voltage V_{com}; a display medium layer 120 arranged between the first substrate 112 and the second substrate 130; and a driver 20 configured to apply, to each of the plurality of pixel electrodes pe, a data voltage corrected based on a distance d between the first edge e1 of the first substrate 112 and each of the plurality of pixel electrodes pe.

No bezel bz may be formed on remaining edges, other than the first edge e1 of the first substrate 112.

The driver 20 may be disposed on the bezel bz.

The driver 20 may be configured to determine a target data voltage V_{data}’ applied to each of the plurality of pixel electrodes pe based on input data, and correct the target data voltage V_{data}’ based on the distance between the first edge e1 of the first substrate 112 and each of the plurality of pixel electrodes pe to determine the corrected data voltage V_{data}.

A correction amount V_{md} of the data voltage may be proportional to the distance between the first edge e1 of the first substrate 112 and each of the plurality of pixel electrodes pe.

The plurality of pixel electrodes pe may include a first pixel electrode which is a first distance away from the first edge e1 of the first substrate 112, and a second pixel electrode which is a second distance away from the first edge e1 of the first substrate 112, wherein the second distance may be greater than the first distance, and in response to a target data voltage corresponding to the first pixel electrode and the second pixel electrode being a first data voltage and a second data voltage, respectively, the driver 20 may be configured to: adjust the first data voltage by a first voltage and apply the adjusted first data voltage to the first pixel electrode, and adjust the second data voltage by a second voltage and apply the adjusted second data voltage to the second pixel electrode, and a magnitude of the second voltage may be greater than a magnitude of the first voltage.

The electrophoretic display module 10 may further include: a conductive member 12 formed in the bezel bz and configured to apply the reference voltage V_{com} to the second substrate 130.

The reference voltage V_{com} applied to the second substrate 130 through the conductive member 12 may decrease due to a voltage drop as a distance from the first edge e1 of the first substrate 112 increases.

According to an embodiment of the disclosure, an electrophoretic display apparatus may include the plurality of electrophoretic display modules 10, and at least one of remaining edges of the first substrate 112 of each of the plurality of electrophoretic display modules 10, other than the first edge e1 of the first substrate 112, may be in contact with at least one of remaining edges of the first substrate 112 of another electrophoretic display module 10 among the plurality of electrophoretic display modules 10, other than the first edge e1 of the first substrate 112.

According to an embodiment of the disclosure, an electrophoretic display module 10 may include: a first substrate 112 including a display area on which a plurality of pixel electrodes pe are provided; a first bezel bz coupled to a first edge e1 of the first substrate 112; a second bezel bz coupled to a second edge e2 opposite to the first edge e1 of the first substrate 112; a second substrate 130 arranged above the first substrate 112 and configured to receive a reference voltage V_{com}; a display medium layer 120 arranged between the first substrate 112 and the second substrate 130; and a driver 20 configured to apply, to each of the plurality of pixel electrodes pe, a data voltage corrected based on a distance d between a virtual reference line VL between the first edge e1 and the second edge e2 of the first substrate 112 and each of the plurality of pixel electrodes pe.

No bezel bz may be formed on remaining edges e3 and e4 of the first substrate 112, other than the first edge e1 and the second edge e2.

The driver 20 may be disposed on at least one of the first bezel bz or the second bezel bz.

The driver 20 may be configured to determine a target data voltage V_{data’} applied to each of the plurality of pixel electrodes pe based on input data, and correct the target data voltage based on the distance d between the virtual reference line VL and each of the plurality of pixel electrodes pe to determine the corrected data voltage.

A correction amount V_{md} of the data voltage may be inversely proportional to a distance between the virtual reference line VL and each of the plurality of pixel electrodes pe.

The plurality of pixel electrodes pe may include a first pixel electrode pe which is a first distance away from the virtual reference line VL, and a second pixel electrode pe which is a second distance away from the virtual reference line VL, wherein the second distance may be greater than the first distance, and in response to a target data voltage corresponding to the first pixel electrode and the second pixel electrode being a first data voltage and a second data voltage, respectively, the driver 20 may be configured to: adjust the first data voltage by a first voltage and apply the adjusted first data voltage to the first pixel electrode, and adjust the second data voltage by a second voltage and apply the adjusted second data voltage to the second pixel electrode, and a magnitude of the first voltage may be greater than a magnitude of the second voltage.

The electrophoretic display module 10 may further include: a first conductive member 12 formed in the first bezel bz and configured to apply the reference voltage V_{com} to the second substrate 130, and a second conductive member 12 formed in the second bezel bz and configured to apply the reference voltage V_{com} to the second substrate 130.

The reference voltage V_{com} applied to the second substrate 130 through each of the first conductive member 12 and the second conductive member 12 may decrease due to a voltage drop as a distance to the virtual reference line decreases.

The virtual reference line VL may be parallel to the first edge e1 and the second edge e2,

and pass through a midpoint between the first edge e1 and the second edge e2.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

The computer-readable recording medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the ‘non-transitory storage medium’ may include a buffer that temporarily stores data.

The methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store^{TM}) online. In the case of online distribution, at least a portion of the computer program product may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. An electrophoretic display module, comprising:
a first substrate having a plurality of edges and including a plurality of pixel electrodes;
a bezel coupled to a first edge of the plurality of edges of the first substrate;
a second substrate arranged above the first substrate and configured to receive a reference voltage;
a display medium layer arranged between the first substrate and the second substrate; and
a driver configured to apply, to each pixel electrode of the plurality of pixel electrodes, a data voltage corrected based on a distance between the first edge of the first substrate and each pixel electrode of the plurality of pixel electrodes such that the reference voltage received by the second substrate and the corrected data voltage applied to each pixel electrode of the plurality of pixel electrodes drive the display medium layer.

2. The electrophoretic display module of claim 1, wherein no bezel is formed on remaining edges other than the first edge of the plurality of edges.

3. The electrophoretic display module of claim 1, wherein the driver is on the bezel.

4. The electrophoretic display module of claim 1, wherein
the driver is configured to determine a target data voltage applied to each pixel electrode of the plurality of pixel electrodes based on input image data, and correct the target data voltage based on the distance between the first edge of the first substrate and each pixel electrode of the plurality of pixel electrodes to determine the corrected data voltage.

5. The electrophoretic display module of claim 1, wherein a correction amount of the corrected data voltage is proportional to the distance between the first edge of the first substrate and each pixel electrode of the plurality of pixel electrodes.

6. The electrophoretic display module of claim 1, wherein the plurality of pixel electrodes includes a first pixel electrode at a first distance from the first edge of the first substrate, and a second pixel electrode at a second distance from the first edge of the first substrate, the second distance being greater than the first distance, and
based on a target data voltage corresponding to the first pixel electrode and the second pixel electrode being a first data voltage and a second data voltage, respectively, the driver is configured to:
adjust the first data voltage by a first voltage and apply the adjusted first data voltage to the first pixel electrode, and
adjust the second data voltage by a second voltage and apply the adjusted second data voltage to the second pixel electrode, and
a magnitude of the second voltage is greater than a magnitude of the first voltage.

7. The electrophoretic display module of claim 1, further comprising:
a conductive member in the bezel and configured to apply the reference voltage received by the second substrate.

8. The electrophoretic display module of claim 7, wherein the reference voltage applied to the second substrate through the conductive member decreases due to a voltage drop as a distance from the first edge of the first substrate increases.

9. An electrophoretic display apparatus comprising the electrophoretic display module of claim 1 as a first electrophoretic module among a plurality of electrophoretic display modules according to claim 1, wherein at least one remaining edge among the remaining edges of the first substrate of the first electrophoretic module, other than the first edge of the first substrate of the first electrophoretic module, is in contact with at least one remaining edge of remaining edges of a first substrate of a second electrophoretic display module among the plurality of electrophoretic display modules.9. An electrophoretic display apparatus comprising the electrophoretic display module of claim 1 as a first electrophoretic module among a plurality of electrophoretic display modules according to claim 1, wherein at least one remaining edge among the remaining edges of the first substrate of the first electrophoretic module, other than the first edge of the first substrate of the first electrophoretic module, is in contact with at least one remaining edge of remaining edges of a first substrate of a second electrophoretic display module among the plurality of electrophoretic display modules.

10. The electrophoretic display module of claim 1, wherein the bezel is a first bezel,
a second edge among the plurality of edges is opposite to the first edge,
the electrophoretic display module further comprises a second bezel coupled to the second edge, and
the driver is configured to apply, to each pixel electrode of the plurality of pixel electrodes, a data voltage corrected based on a distance between a virtual reference line between the first edge and the second edge of the first substrate and each pixel electrode of the plurality of pixel electrodes.

11. The electrophoretic display module of claim 10, wherein no bezel is formed on remaining edges of the plurality of edges.

12. The electrophoretic display module of claim 10, wherein the driver is disposed on at least one of the first bezel or the second bezel.

13. The electrophoretic display module of claim 10, wherein the driver is configured to determine a target data voltage applied to each pixel electrode of the plurality of pixel electrodes based on input image data, and correct the target data voltage based on the distance between the virtual reference line and each pixel electrode of the plurality of pixel electrodes to determine the corrected data voltage.

14. The electrophoretic display module of claim 10, wherein a correction amount of the data voltage is inversely proportional to the distance between the virtual reference line and each pixel electrode of the plurality of pixel electrodes.

15. The electrophoretic display module of claim 10, wherein the virtual reference line is parallel to the first edge and the second edge, and passes through a midpoint between the first edge and the second edge.

16. The electrophoretic display module of claim 10, wherein the plurality of pixel electrodes comprises a first pixel electrode which is a first distance away from the virtual reference line, and a second pixel electrode which is a second distance away from the virtual reference line,
wherein the second distance is greater than the first distance, and
wherein in response to a target data voltage corresponding to the first pixel electrode and the second pixel electrode each being a first data voltage and a second data voltage, the driver is configured to adjust the first data voltage by a first voltage and apply the adjusted first data voltage to the first pixel electrode, and adjust the second data voltage by a second voltage and apply the adjusted second data voltage to the second pixel electrode,
wherein a magnitude of the first voltage may be greater than a magnitude of the second voltage.

17. The electrophoretic display module of claim 10, further comprising a first conductive member formed in the first bezel and configured to apply the reference voltage to the second substrate, and a second conductive member formed in the second bezel and configured to apply the reference voltage to the second substrate.

18. The electrophoretic display module of claim 17, wherein the reference voltage applied to the second substrate through each of the first conductive member and the second conductive member decreases due to a voltage drop as a distance to the virtual reference line decreases.
